(19) United States
(12) Patent Application Publication
(10) Pub. No.: US 2014/0358786 A1
(43) Pub. Date: Dec. 4, 2014

(54) VIRTUAL CERTIFIED FINANCIAL INSTRUMENT SYSTEM

(71) Applicant: The Toronto-Dominion Bank, Mississauga (CA)

(72) Inventors: Lauren VAN HEERDEN, Bedford, NH (US); Michael D. Cummins, Pickering (CA); Prabaharan Sivashanmugam, Farmington Hills, MI (US); Gunalan Nadarajah, Milton (CA); Orin Del Vecchio, Richmond Hill (CA)

(73) Assignee: The Toronto-Dominion Bank, Mississauga (CA)

(21) Appl. No.: 14/289,261

(22) Filed: May 28, 2014

Related U.S. Application Data
(60) Provisional application No. 61/828,055, filed on May 28, 2013.

(51) Int. Cl. G06Q 20/38

(52) U.S. Cl. CPC G06Q 20/3821
USPC 705/44

(57) ABSTRACT

The disclosed embodiments include systems and methods for issuing a virtual certified financial instrument. The disclosed embodiments may be configured to receive a financial instrument request for a virtual certified financial instrument, generate a payor token and a payee token, generate a reference token from the payor token and the payee token using an algorithm rendering it computationally infeasible for the reference token to be derived from only one of the payor token and the payee token, and uniquely associate the reference token with the virtual certified financial instrument. The disclosed embodiments may also be configured to receive, from the payor device or the payee device, a financial instrument redemption request that includes a composite token, and redeem the virtual financial instrument in accordance with a confirmation that the composite token matches the reference token.

### CROSS-REFERENCE TO RELATED APPLICATIONS

This application claims the benefit of priority to U.S. Provisional Patent Application No. 61/828,055, filed May 28, 2013, the disclosure of which is incorporated herein by reference to its entirety.

### BACKGROUND

1. Technical Field

The disclosed embodiments generally relate to computerized systems and methods for issuing financial instruments.

2. Background Information

To obtain a certified financial instrument, such as a bank draft, money order, certified cheque, or other financial instrument that designates a person as the intended payee, the payor must typically attend at the premises of the payor's financial institution. Often the payor must wait in line at the financial institution, and/or wait for a senior employee of the financial institution approve release of financial instrument.

### SUMMARY

The disclosed embodiments include a communications device, financial instrument processing server, and associated computer-implemented methods for issuing and redeeming virtual certified financial instruments.

In some embodiments, a method of issuing a virtual certified financial instrument includes, by a financial instrument processing server, receiving a financial instrument request for a virtual certified financial instrument for effecting a payment to a payee, generating a payor token and a payee token, generating a reference token from the payor token and the payee token using an algorithm that renders it computationally infeasible for the reference token to be derived from only one of the payor token and the payee token, and uniquely associating the reference token with the virtual certified financial instrument.

The financial instrument processing server may transmit the payor token to a payor of the virtual certified financial instrument via a first communications channel, and transmit the payee token to the payee via a second communications channel that is distinct from the first communications channel. The payor device may be associated with a payor of the virtual financial instrument, and the payee device may be associated with the payee. The financial instrument processing server may also receive, from one of the payor device and the payee device, a financial instrument redemption request that includes a composite token, and may redeem the financial instrument in favour of the payee in accordance with a confirmation that the composite token matches the reference token.

In additional embodiments, a financial instrument processing server includes a network interface, a storage device, and at least one processor coupled to the network interface and the storage device. The storage device may store software instructions for controlling the at least one processor when executed by the at least one processor, and the at least one processor may be operative with the software instructions and may be configured to receive a financial instrument request for a virtual certified financial instrument for effecting a payment to a payee.

The at least one processor may be further configured to generate a payor token and a payee token, generate a reference token from the payor token and the payee token using an algorithm rendering it computationally infeasible for the reference token to be derived from only one of the payor token and the payee token, and uniquely associate the reference token with the virtual certified financial instrument. The at least one processor may be further configured to transmit the payor token to a payor device via a first communications channel, and transmit the payee token to a payee device via a second communications channel that is distinct from the first communications channel. The payor device may be associated with a payor of the virtual financial instrument, and the payee device is associated with the payee. Further, the at least one processor may be configured to receive, from one of the payor device and the payee device, a financial instrument redemption request that includes a composite token, and redeem the virtual financial instrument in favour of the payee in accordance with a confirmation that the composite token matches the reference token.

As outlined below, by confirming that the composite token matches the reference token, in effect the financial instrument processing server confirms that the composite token was generated from the payor token and the payee token. Accordingly, the financial instrument processing server may, in effect, redeem upon confirming that the composite token is a virtual certified financial instrument.

In further embodiments, accordance, a method of redeeming a virtual certified financial instrument includes, at a payee communications device, receiving a payor token from a payor communications device via a first communications channel, and receiving a payee token from a financial instrument processing server via a second communications channel that is distinct from the first communications channel. From the payor token and the payee token the payee, the payee communications device may generate a financial instrument redemption request that includes a composite token, and transmit the financial instrument redemption request to the financial instrument processing server.

The payee communications device may receive, from the financial instrument processing server, a notification confirming redemption of the virtual financial instrument in favour of a payee. The notification may be generated in accordance with a confirmation that the financial instrument processing server generated a reference token from the payor token and the payee token using an algorithm that renders it computationally infeasible for the reference token to be derived from only one of the payor token and the payee token, uniquely associated the reference token with the payor token and the payee token, and that the composite token matches the reference token. From the notification, the payee communications device may generate an output confirming redemption of the financial instrument in favour of the payee.

In other embodiments, a communications device includes a communication system, a storage device, and at least one processor coupled to the communication system and the storage device. The storage device may store software instructions for controlling the at least one processor when executed by the at least one processor, and the at least one processor may be operative with the software instructions and is configured to receive a payor token from a payor communications device via a first communications channel and receive a payee token from a financial instrument processing server via a second communications channel that is distinct from the first communications channel, generate from the payor token and the payee token a financial instrument redemption request, and transmit the financial instrument redemption request to the financial instrument processing server.

The at least one processor may be further configured to to receive, from the financial instrument processing server, a notification confirming redemption of a virtual financial instrument in favour of a payee. The notification may be generated in accordance with a confirmation that the financial instrument processing server generated a reference token from the payor token and the payee token using an algorithm that renders it computationally infeasible for the reference token to be derived from only one of the payor token and the payee token, uniquely associated the reference token with the payor token and the payee token, and that the composite token matches the reference token. From the notification, the payee communications device may generate an output confirming redemption of the financial instrument in favour of the payee. The at least one processor may be further configured to generate from the notification an output confirming redemption of the financial instrument in favour of the payee.

In additional embodiments, a tangible, non-transitory computer-readable medium stores instructions which, when executed by at least one processor, cause the at least one processor to perform a method of issuing a virtual certified financial instrument. The method may include receiving a financial instrument request for a virtual certified financial instrument for effecting a payment to a payee, generating a payor token and a payee token, generating a reference token from the payor token and the payee token using an algorithm rendering it computationally infeasible for the reference token to be derived from only one of the payor token and the payee token, and uniquely associating the reference token with the virtual certified financial instrument. The method may also include transmitting (i) the payor token to a payor device via a first communications channel, and (ii) the payee token to a payee device via a second communications channel distinct from the first communications channel, the payor device being associated with a payor of the virtual financial instrument, the payee device being associated with the payee. The method may include receiving a financial instrument redemption request from one of the payor device and the payee device. In some aspects the financial instrument redemption request including a composite token. The method further includes redeeming the virtual financial instrument in favour of the payee in accordance with a confirmation that the composite token matches the reference token.

In some aspects, since the financial instrument processing server transmits the payor token via a first communications channel, transmits the payee token via a second communications channel distinct from the first communications channel, and redeems the certified financial instrument in accordance with confirmation that the composite token matches a reference token that was generated from the payor token and the payee token using an algorithm that renders it computationally infeasible for the reference token to be derived from only one of the payor token and the payee token, the likelihood of the financial instrument redemption request being subject to a successful man-in-the-middle attack is reduced.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

An exemplary certified financial instrument processing network, and method for issuing and redeeming virtual certified financial instruments, will now be described, with reference to the accompanying drawings, in which:

FIG. 1 is a schematic view of the financial instrument processing environment, depicting a financial instrument processing server and a plurality of communications devices, in accordance with disclosed embodiments;

FIG. 2 is a diagram of an exemplary communications device, consistent with enclosed embodiments;

FIG. 3 is a diagram of an exemplary financial instrument processing server, consistent with the disclosed embodiments; and

FIG. 4 is a flow diagram of an exemplary method of issuing and redeeming virtual certified financial instruments, consistent with the disclosed embodiments.

### DETAILED DESCRIPTION

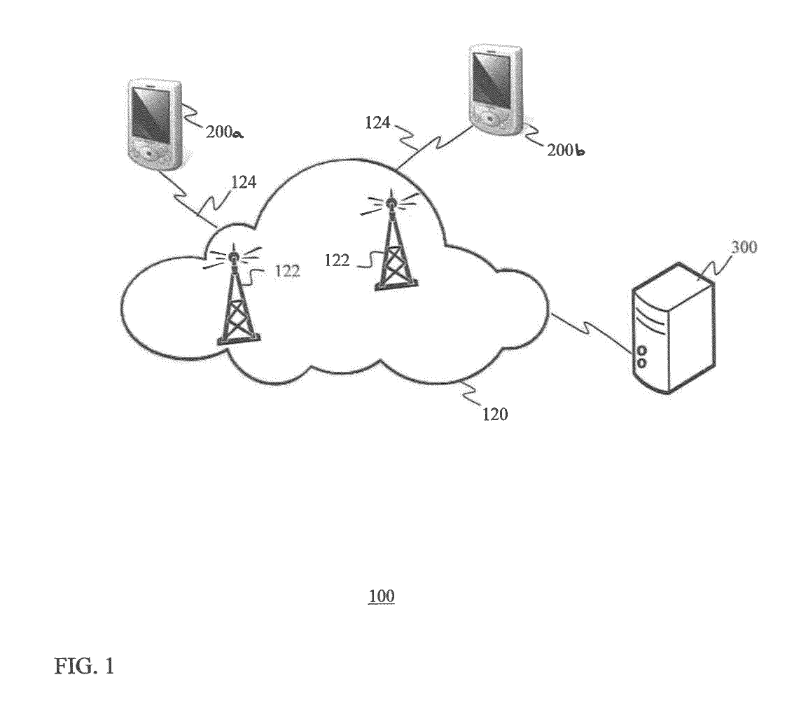

FIG. 1 is a schematic view of a certified financial instrument processing environment, denoted generally as 100. As shown, the financial instrument processing environment 100 comprises a first communications device 200a, a second communications device 200b (collectively, communications devices 200), and a financial instrument processing server 300. Although the financial instrument processing environment 100 of FIG. 1 includes only two communications devices 200, the financial instrument processing environment 100 may include a plurality of the communications devices 200. Moreover, although the financial instrument processing environment 100 of FIG. 1 includes a single financial instrument processing server 300, the financial instrument processing environment 100 may include a plurality of financial instrument processing servers 300.

One or more of the communications devices 200a and 200b may be implemented as a wireless communications device configured to operate within a wireless network. Accordingly, the financial instrument processing environment 100 may also include a mobile communications network 120. The mobile communications network 120 may be configured as a WiFi network, a cellular network, or a combination thereof. As shown, the mobile communications network 120 may include a plurality of wireless base station subsystems 122. The communications devices 200 may communicate with the base station subsystems 122 via wireless links 124, and the base station subsystems may communicate with the financial instrument processing server 300 via a wired, wireless or optical link. Accordingly, the base station subsystems 122 may act as a bridge between the wireless links 124 and the financial instrument processing network 100. Further, one or more of the communications devices 200 may be implemented as a point-of-sale (POS) terminal that is configured to communicate with other communications devices 200, for example using Bluetooth and/or Near Field Communications (NFC).

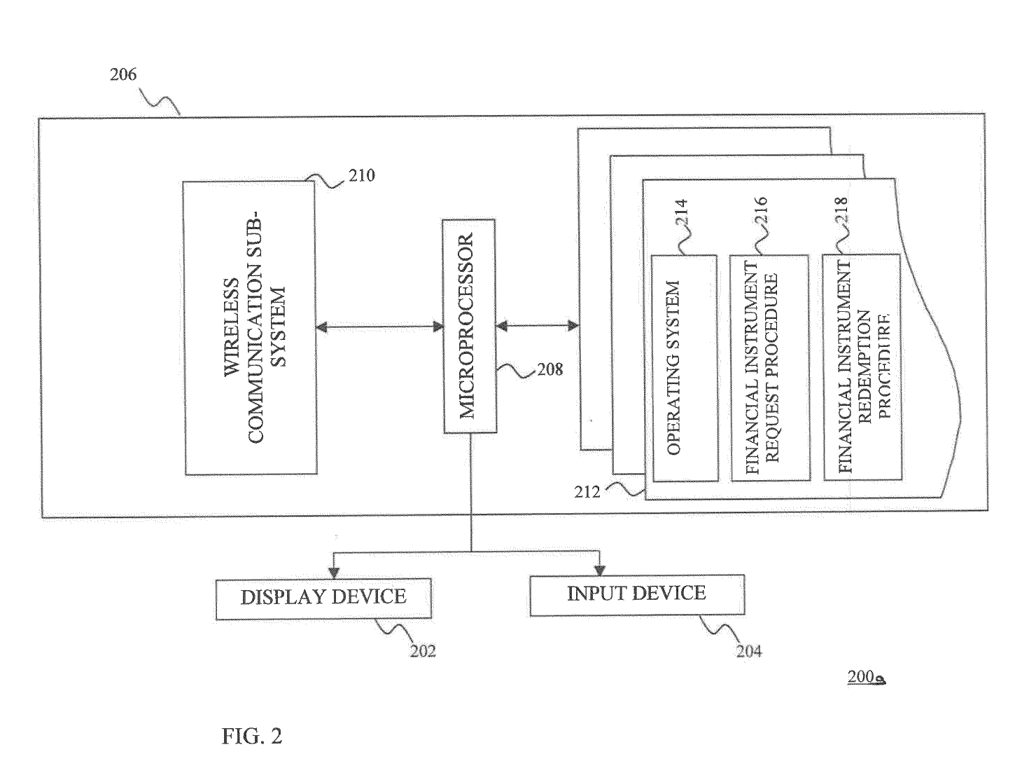

FIG. 2 illustrates an exemplary communications device 200a, implemented as a wireless communications device, in accordance with disclosed embodiments. As shown, the communications device 200a includes a display 202, user input device 204, and a data processing system 206. The user input device 204 may be provided as a keyboard and/or a touch-sensitive layer provided on the display 202. The data processing system 206 may include a microprocessor 208, a wireless communication sub-system 210, and a memory 212 (e.g., a tangible, non-transitory computer-readable storage medium). The communication sub-system 210 may allow the communications device 200a to communicate with the mobile communications network 120. As discussed, the mobile communications network 120 may be configured as a WiFi network, a cellular network, or a combination thereof. Accordingly, the communication sub-system 210 may allow the communications device 200a to transmit and receive wireless communications signals over WiFi networks and/or cellular networks.

The memory 212 may include a tangible, non-transitory computer-readable storage medium storing instructions which, when accessed from the memory 212 and executed by the microprocessor 208, implement an operating system 214, and to perform steps of a financial instrument request procedure 216 and a financial instrument redemption procedure 218. The operating system 214 is configured to display output on the display 202, to receive user input from the input device 204, and to send and receive communication signals over the wireless link 124 of the mobile communications network 120. The operation of the financial instrument request procedure 216 and the financial instrument redemption procedure 218 will be discussed in greater detail below. By way of example, the communication device 200 may implement the financial instrument request procedure 216 to generate, from particulars input from the user input device 204, a request for a virtual certified financial instrument, and to transmit the financial instrument request to the financial instrument processing server 300, via the mobile communications network 120. The virtual financial instrument may effect a payment to a payee, and the financial instrument request identifies a payment amount for the virtual financial instrument.

In some aspects, communications device 200a may implement the financial instrument request procedure 216 to receive from the financial instrument processing server 300, via the mobile communications network 120. In some aspects, a payor token that may be generated by the financial instrument processing server 300 in response to the financial instrument request. The payor token may, for example, include an encoded electronic message, and the communications device 200 may perform steps of the financial instrument request procedure 216 to generate a visual representation of the payor token (e.g. a two-dimensional bar code (QR code)) and display the visual representation on the display 202 for capture by another communications device 200b.

Alternately, the communications device 200a may implement the financial instrument request procedure 216 to directly or indirectly wirelessly transmit the visual representation of the payor token to another communications device 200b. In another aspect, instead of generating a visual representation of the payor token, the communications device 200a may wirelessly transmits the payor token directly or indirectly to the other communications device 200. By way of example, the communications device 200a may implement the financial instrument request procedure 216 to wirelessly transmit the payor token (and/or the visual representation thereof) directly to the other communications device 200 (for example, via Bluetooth or NFC), or indirectly to the other communications device 200 (for example, via WiFi or cellular communications) using a relay and proximity service, such as the relay and proximity service provided by Bump Technologies.

In some embodiments, communications device 200a may implement the financial instrument redemption procedure 218 to receive a payor token from another communications device 200 via a first communications channel and to receive a payee token from the financial instrument processing server 300 via a second communications channel that is distinct from the first communications channel. The communications device 200a may generate a composite token from the payor token and the payee token, and may transmit the financial composite token to the financial instrument processing server 300.

In certain aspects, the visual representation of the payor token may have been displayed on the display 202 of the other communications device, and communications device 200a may implement the financial instrument redemption procedure 218 to receive the payor token via an image capture device incorporated into the communications device 200a. Alternately, the communication device 200a may wirelessly receive the payor token (and/or the visual representation thereof) from the other communications device 200b. By way of example, communications device 200a may receive the payor token directly from the other communications device 200 (for example, via Bluetooth or NFC), or indirectly (for example, via WiFi or cellular communications) using a relay and proximity service.

The communications device 200a may also be configured to implement the financial instrument redemption procedure 218 to receive, from the financial instrument processing server 300, a notification confirming redemption of a virtual certified financial instrument in favour of a payee, and to generate from the notification an output confirming the redemption of the virtual financial instrument in favour of the payee. The notification may be generated in accordance with a confirmation that the financial instrument processing server 300 generated a reference token from the payor token and the payee token using an algorithm that, for example, renders it computationally infeasible for the reference token to be derived from only one of the payor token and the payee token, uniquely associates the reference token with the payor token and the payee token, and that matches the composite token to the reference token.

In some embodiments, the communications device 200a may be implemented as a POS terminal, the communications device 200a may have a similar configuration to that of the aforementioned wireless communications device, but with the communication sub-system 210 configured to allow the communications device 200a to communicate via Bluetooth and/or NFC and to communicate with the merchant's acquirer network.

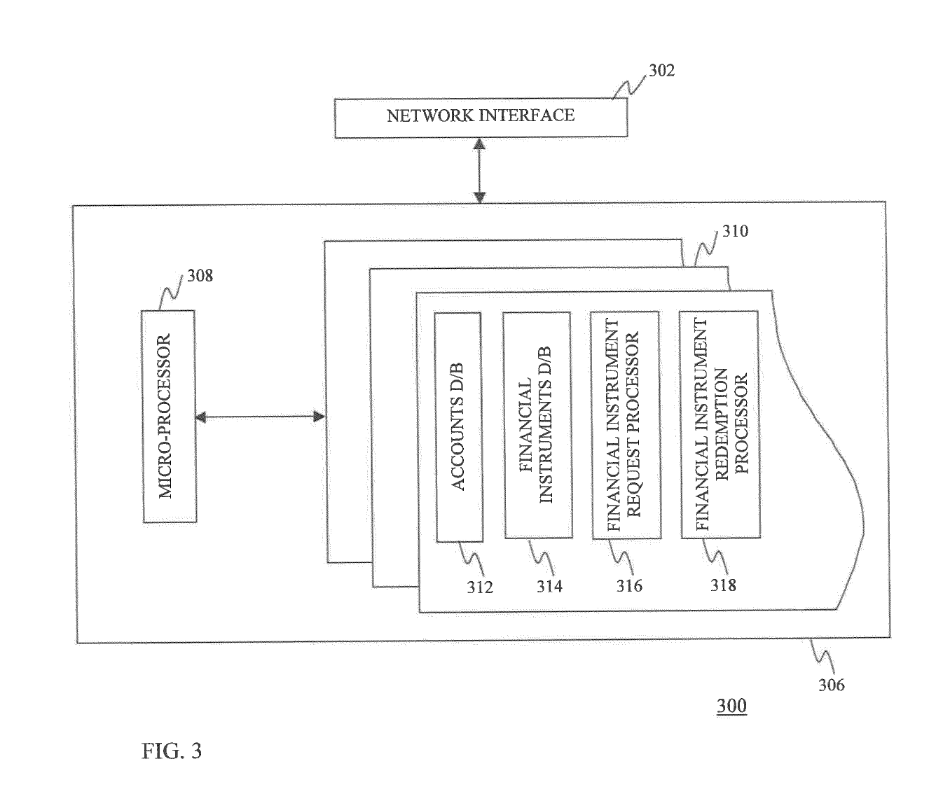

FIG. 3 illustrates an exemplary financial instrument processing server 300, consistent with the disclosed embodiments. The financial instrument processing server 300 may, for example, be implemented as a computer server or other component of a computer system, and may be configured to execute software instructions to redeem a virtual certified financial instrument by effecting a payment to a payee account. In some embodiments, the financial instrument processing server 300 may maintain a payor account and the payee account. By way of example, the financial instrument processing server 300 may include a financial institution server, the payor's account and the payee's account may include any of a savings account, a chequing account, a credit account and a line of credit account, and the financial instrument processing server 300 may be configured to execute software instructions that withdraw funds from the payor's account and to deposit funds to the payee's account.

In the embodiments described above, the financial instrument processing server 300 maintains both the payor's account and the payee's account. In other aspects, the payor's account and the payee's account may be maintained by respective account servers (e.g. respective financial institution servers), and the financial instrument processing server 300 may act as a trusted intermediary to the respective account servers. In some instances, the financial instrument processing server 300 may execute instructions to withdraw funds from the payor's account and deposit funds to the payee's account via the payor account server and the payee account server.

As shown in FIG. 3, the financial instrument processing server 300 includes a network interface 302, and a computer processing system 306 that is coupled to the network interface 302. The network interface 302 may interface the financial instrument processing server 300 with the base station subsystems 122 of the mobile communications network 120 and allow the financial instrument processing server 300 to communicate with the communications devices 200a and 200b. Further, if the financial instrument processing server 300 acts as a trusted intermediary to the payor's and the payee's respective account servers, the network interface 302 may also interface the financial instrument processing server 300 with a payment network that comprises the account servers.

The computer processing system 306 may include one or more microprocessors 308 and a computer-readable storage medium 310. The computer-readable storage medium 310 may include a tangible, non-transitory computer-readable storage medium, such as electronic computer memory (e.g. flash memory) or optical or magnetic memory (e.g. compact disc, hard disk).

The computer-readable storage medium 310 may maintain an accounts database 312 and a financial instruments database 314. The accounts database 312 may include a plurality of data clusters, each associated with a respective payor or payee account. Each data cluster may, for example, include a plurality of database records, each identifying a credit/deposit entry to an associated account. Each data cluster may also include a credential (e.g. user ID, e-mail address, etc.) that may be uniquely associated with the respective account holder. As will be discussed below, the financial instrument processing server 300 may be configured to use the credential to transmit to a payee a payee token that is uniquely associated with a request for a virtual certified financial instrument.

The financial instruments database 314 may, for example, include a plurality of data clusters, each associated with a respective virtual certified financial instrument that has not yet been redeemed. In some aspects, each data cluster may include a payment token that is uniquely associated with the respective virtual certified financial instrument, and identifies the payment amount for the respective virtual certified financial instrument.

The computer-readable medium 310 may also store instructions which, when executed by the microprocessor(s) 308, implement an operating system (not shown) that controls an overall operation of the financial instrument processing server 300. The microprocessor(s) 308 may also execute the stored instructions to implement a financial instrument request processor 316 and a financial instrument redemption processor 318.

In some aspects, the financial instrument request processor 316 may be configured to receive, from a payor communications device (e.g., communications device 200a), a request for a virtual certified financial instrument. The virtual financial instrument may, for example, effect a payment to a payee, and the financial instrument request identifies the payment amount for the virtual financial instrument.

The financial instrument request processor 316 may also be configured to generate a payor token and a payee token, and generate a reference token from the payor token and the payee token, and uniquely associate the reference token with the specified payment amount. In some embodiments, the financial instrument request processor 316 may uniquely associate the reference token with the payment amount and the payee. Further, in other embodiment, the financial instrument request processor 316 may be configured to generate the reference token using an algorithm that renders it computationally infeasible for the reference token to be derived from one or more of the payor token and the payee token, and additionally of alternatively, from only the payor token and the payee token.

The financial instrument request processor 316 may also be configured to transmit the payor token to the payor's communications device 200a via a first communications channel, and to transmit the payee token to the payee's communications device (e.g., communications device 200b) via a second communications channel that is different from the first communications channel.

The financial instrument redemption processor 318 may be configured to receive, from the payee's communications device 200b, a financial instrument redemption request that includes a composite token, and to confirm that the composite token matches the reference token that is uniquely associated with the virtual certified financial instrument. The financial instrument redemption processor 318 may also be configured to redeem the financial instrument, and effect a payment to the payee, in accordance with an outcome of the confirmation.

In the embodiments described above, the financial instrument processing server 300 may execute stored computer processing instructions to implement the financial instrument request processor 316 and the financial instrument redemption processor 318 and perform the exemplary processes described above. In other embodiments, however, all or a portion of the functionality of the financial instrument request processor 316 and/or the financial instrument redemption processor 318 may be implemented instead in electronics hardware, e.g., using a special-purpose computer or computing system.

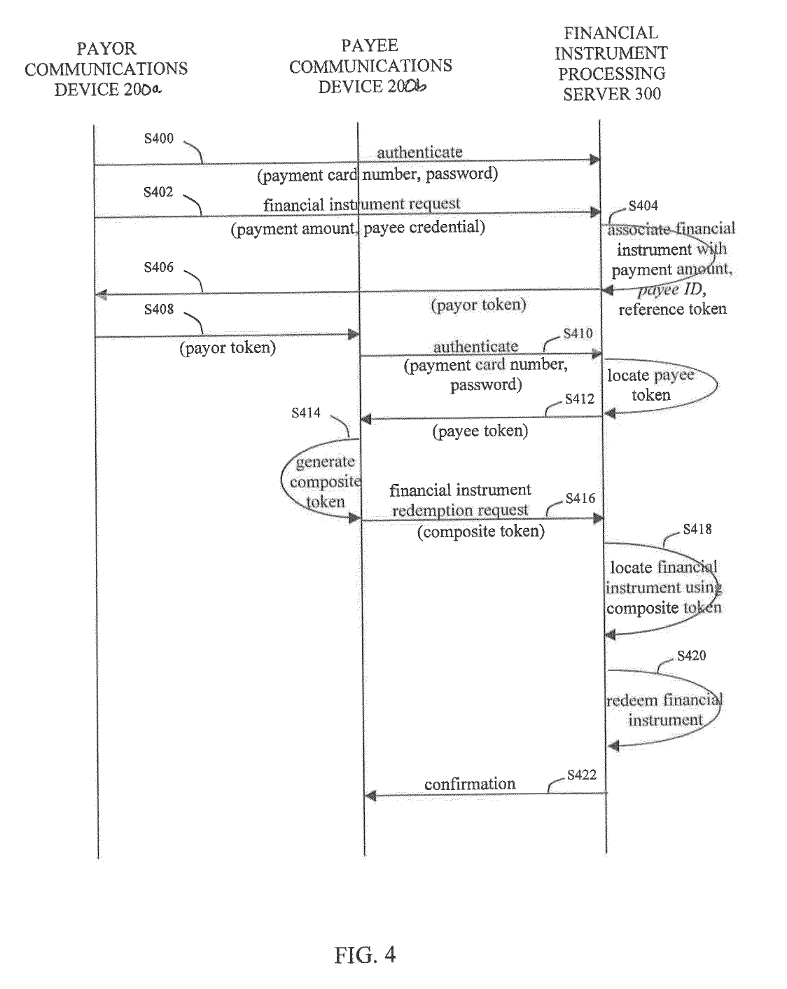

As discussed above, one or more of the components of the financial instrument processing environment 100 may execute computer processing instructions to issue and redeem virtual certified financial instruments. FIG. 4 illustrates an exemplary process for issuing and redeeming virtual certified financial instruments, consistent with disclosed embodiments. In certain embodiments, a person (payor) may request issuance of a virtual certified financial instrument by using the payor's communications device 200a to transmit a financial instrument request to the financial instrument processing server 300. The virtual financial instrument may, for example, effect a payment in a payment amount to another person (payee), and the financial instrument request identifies the payment amount for the virtual financial instrument.

In some aspects, the financial instrument processing server 300 generates a payor token and a payee token, generates a reference token from the payor token and the payee token preferably using an algorithm that renders it computationally infeasible for the reference token to be derived from only one of the payor token and the payee token, and uniquely associates the reference token with the virtual certified financial instrument. The financial instrument processing server 300 may transmit the payor token to a payor of the virtual certified financial instrument via a first communications channel, and transmits the payee token to the payee via a second communications channel that is distinct from the first communications channel.

The payee may initiate redemption of the virtual financial instrument by using the payee's communications device 200b to transmit to the financial instrument processing server 300 a financial instrument redemption request that includes a composite token. The financial instrument processing server 300 may receive the financial instrument redemption request, and may execute instructions to redeem the financial instrument in favour of the payee in accordance with a confirmation that the composite token matches the reference token that was uniquely associated with the virtual financial instrument.

In FIG. 4, the payor may use payor communications device 200a to establish an encrypted communications channel with financial instrument processing server 300, and may authenticate to the financial instrument processing server 300 (e.g., in step S400). In some embodiments, the payor communications device 200a may authenticate the payor to the financial instrument processing server 300 by providing the financial instrument processing server 300 with the authentication credentials (e.g. payment card number and password) that the payor uses to initiate electronic banking with the financial instrument processing server 300 (and/or with a server or computer system associated with the user's financial institution).

After the payor successfully authenticates to the financial instrument processing server 300, the payor may invoke the financial instrument request procedure 216 on the payor communications device 200a, as described above. In some aspects, the payor communications device 200a may, during implementation of the financial instrument request procedure 216, prompt the payor to enter a payment amount and to optionally identify the payee for the requested certified financial instrument. As discussed above, the accounts database 312 may include a credential (e.g. user ID, e-mail address, etc.) that is uniquely associated with the respective account holder, and in certain aspects, the payee identification may comprise the payee's unique credential. Further, in some embodiments, the payor communications device 200a may, during implementation of the financial instrument request procedure 216, also prompt the payor to identify an account associated with a payor (e.g., a “payor account”) that the payor would like to use to pay for the virtual financial instrument.

The payor may input the requested information into the payor communications device 200a via the user input device 204. In some aspects, the payor communications device 200a may incorporate the requested information into a financial instrument request, and transmit the financial instrument request to the financial instrument processing server 300 via the secure channel (e.g., at step S402).

In response to the financial instrument request, the financial instrument processing server 300 may verify that the payor account (e.g., as maintained in the accounts database 312) includes sufficient funds for payment of the requested virtual certified financial instrument. If the balance of the payor account is at least equal to the payment amount specified in the financial instrument request, the financial instrument processing server 300 may execute software instructions to withdraw the payment amount from the payor account.

If the financial instrument processing server 300 maintains the payor account in the accounts database 312, the financial instrument processing server 300 may execute software instructions to effect the withdrawal by updating the accounts database 312. However, if the payor account is maintained by a payor account server, the financial instrument processing server 300 may execute software instructions to effect the withdrawal by communicating particulars of the withdrawal to the payor's account server (e.g., over network 120).

Further, in some embodiments, the financial instrument request processor 316 of the financial instrument processing server 300 may insert into the financial instruments database 314 an entry for the requested certified financial instrument (e.g., at step S404). By way of example, the inserted entry may identify the payment amount and the payee (if provided) for the financial instrument.

At step S404, the financial instrument request processor 316 may also generate a unique payor token and a unique payee token, generate a reference token from the payor token and the payee token, and uniquely associate the reference token (and the payor token and payee token) with the virtual financial instrument by inserting the reference token into the financial instruments database 314 in the database cluster associated with the requested virtual financial instrument. The financial instrument request processor 316 may also save the payee credential (if provided) in the financial instruments database 314 in unique association with virtual financial instrument.

In some embodiments, the reference token may be globally unique in the sense that, prior to redemption of the associated virtual financial instrument, the reference token may only be associated with this particular virtual certified financial instrument. The reference token may, for example, be generated from the payor token and the payee token using any suitable algorithm, provided that the payor token and the payee token are uniquely associated with the reference token (i.e. no tokens, other than the payor token and the payee token generated at step S404, can be used to re-generate the reference token). In additional embodiments, the payor token and the payee token may be generated using an algorithm that makes it computationally infeasible for the payor token to be derived only from the payee token (and vice versa) and that also makes it computationally infeasible for the reference token to be derived from only one of the payee token and the payee token. By way of example, the payor token and the payee token may include respective visually-different images that are generated by applying randomly-selected different digital filters or other image processing algorithms to one or more images, and the reference token may be generated by vertically or horizontally interleaving the payor token and payee token together into a single composite image. The payor (or payee) token may include the left (or top) half of the composite image, and the payee (or payor) token may include the right (or bottom) half of the composite image. In certain aspects, the financial instrument request processor 316 may optionally verify that the reference token is unique within the financial instruments database 314. In other aspects, the financial instrument request processor 316 may generate the payor and payee tokens from a pseudo-random number generator and/or a noise generator, or by applying visually-different images (or a random image and a pseudo-random number) as inputs to a hash function, and may generate the reference token by applying the payor and payee tokens as inputs to a hash algorithm and optionally verifying that the reference token is unique within the financial instruments database 314. Other examples will be apparent to those skilled in the art.

At step S406, the financial instrument request processor 316 may transmit the payor token to the payor communications device 200a via the encrypted communications channel (e.g., as established at step S400). The payor communications device 200a saves the payor token in the memory 212.

At step S408, the payor communications device 200a may transmit the payor token to the payee communications device 200b. By way of example, the financial instrument request procedure 216 implemented by the payor communications device 200a may generate a visual representation of the payor token (e.g. a two-dimensional bar code (QR code)) and display the visual representation on the display 202 of the payor communications device 200a. In other aspects, the financial instrument request procedure 216 of the payor communications device 200a may wirelessly transmit the payor token directly (for example, via NFC) or indirectly (for example, via WiFi or cellular communications) to the payee communications device 200b.

To receive the payor token from the payor communications device 200a, the payee may invoke the financial instrument redemption procedure 218 on the payee communications device 200b and select one of the available reception methods associated with by the financial instrument redemption procedure 218 (e.g., as presented to the payee by the payee communications device 200b). If the payor communications device 200a displayed a visual representation of the payor token on the display 202 of the payor communications device 200a, the payee communications device 200b may receive the payor token via an image capture device of the payee communications device 200b. If the payor communications device 200a wirelessly transmitted the payor token, the payee communications device 200b may wirelessly receive the payor token directly (for example via NFC) or indirectly (for example via WiFi or cellular communications).

To initiate redemption of the virtual financial instrument in favour of the payee, the payee communications device 200b may execute instructions (e.g., upon request of the payee) to establish an encrypted communications channel with financial instrument processing server 300. In some aspects, payee communications device 200b may be configured to authenticate (e.g., using the financial instrument redemption procedure 218) to the financial instrument processing server 300 (e.g., at step S410. By way of example, the payee communications device 200b may authenticate the payee by providing the financial instrument processing server 300 with the authentication credentials (e.g. payment card number and password) that the payee normally uses to initiate electronic banking with the financial instrument processing server 300 (or with the user's financial institution server).

After successfully authenticating to the financial instrument processing server 300, the financial instrument processing server 300 may be configured to query the financial instruments database 314 with the payee credential for the payee token (e.g., using financial instrument request processor 316), and at step S412 may transmit the payee token to the payee communications device 200b via the encrypted communications channel established at step S410. The payee communications device 200b may save the payee token in the memory 212.

In other aspects, the payor token may include a pseudo-random financial instrument identifier that the financial instrument processing server 300 uniquely associated with the virtual financial instrument in the financial instruments database 314 at step S404, and the payee communications device 200b (e.g., through the financial instrument redemption procedure 218) may extract the financial instrument identifier from the payor token received at step S408 and transmit the extracted financial instrument identifier to the financial instrument processing server 300 at step S410. In response, the financial instrument processing server 300 (e.g., using the financial instrument request processor 316) may query the financial instruments database 314 with the financial instrument identifier for the payee token that is associated with the financial instrument identifier, and transmit the payee token to the payee communications device 200b at step S412. In another variation, the payor communication device 200a may provide the financial instrument processing server 300 with the e-mail address of the payee at step S402, and the financial instrument request processor 316 may transmit the payee token to the payee by e-mail, using the specified e-mail address, at or prior to step S412.

By way of example, and using the same algorithm that the financial instrument request processor 316 of the financial instrument processing server 300 used to generate the reference token at step S404, the payee communications device 200b (e.g., implementing the financial instrument redemption procedure 218) may generate a composite token from the payor token and the payee token (e.g., at step S414). Therefore, as examples, where the payor token and the payee token comprise respective images, the payee communications device 200b (e.g., implementing the financial instrument redemption procedure 218) may generate the composite token by vertically or horizontally interleaving or otherwise combining the respective images into a single composite image. Where the reference token was generated from a hash algorithm, the payee communications device 200b (e.g., implementing the financial instrument redemption procedure 218) may generate the composite token by applying the payor and payee tokens as inputs to the hash algorithm. The payee communications device 200b (e.g., implementing the financial instrument redemption procedure 218) may incorporate the composite token into a financial instrument redemption request, and transmit the financial instrument redemption request to the financial instrument processing server 300 via the secure channel (e.g., at step S416).

In response, the financial instrument redemption processor 318 of the financial instrument processing server 300 may determine whether the financial instrument redemption request was generated from a payor token and a payee token that are associated with a virtual certified financial instrument. In some aspects, the financial instrument redemption processor 318 of the financial instrument processing server 300 may extract the composite token from the financial instrument redemption request and queries the financial instruments database 314 for an entry having a reference token matching the composite token (e.g., in step 418).

When the financial instrument redemption processor 318 locates a reference token in the financial instruments database 314 matching the composite token, the financial instrument redemption processor 318 of the financial instrument processing server 300 may confirm that the composite token is a virtual certified financial instrument. Accordingly, after confirming that the composite token is a virtual certified financial instrument, the financial instrument processing server 300 may prompt the payee, through payee communications device 200b, to provide particulars of the account that the payee would like to use to redeem the certified financial instrument (e.g., a “payee account” into which the payee would like the payment to be deposited). The financial instrument processing server 300 may execute software instructions to redeems the virtual financial instrument in favour of the payee, at step S420, by depositing the payment amount into the payee account, and delete the reference token (and the corresponding database entry of the virtual financial instrument) from the financial instruments database 314. In certain aspects, the financial instrument redemption processor 318 may redeem the virtual financial instrument and delete the reference token from the financial instruments database 314 in step 420.

In the embodiments described above, the payee communications device 200b receives the payor token prior to receiving the payee token. In other aspects, however, the payee communications device 200b receives the payee token prior to receiving the payor token. Further, in some embodiments, the payee communications device 200b may receive the payor token from the payor, generate the composite token, and transmit the financial instrument redemption request to the financial instrument processing server 300. In other embodiments, the payor communications device 200a may receive the payee token from the payee communications device 200b, generate the composite token, and transmit the financial instrument redemption request to the financial instrument processing server 300. For example, the payee may choose not to authenticate to the financial instrument processing server 300, but to receive the payee token via e-mail at the payee communications device 200b. In other embodiments, the payor communications device 200a may generate the composite token, and transmit the composite token to the payee communications device 200b.

As discussed above, the financial instrument request processor 316 may uniquely associate the reference token with the payment amount and the payee (e.g., via the payee credential). In some aspects, as the financial instrument redemption processor 318 redeems the virtual financial instrument upon confirming that the composite token matches a reference token stored in the financial instruments database 314, the financial instrument redemption processor 318 may effectively redeem the virtual financial instrument upon confirming that the financial instrument redemption request originated from the payee.

If the financial instrument processing server 300 maintains the payee account in the accounts database 312, the financial instrument processing server 300 may execute software instructions to effect the deposit by updating the accounts database 312. However, if the payee account is maintained by a payee account server, the financial instrument processing server 300 may execute software instructions to effect the deposit by communicating particulars of the deposit to the payee's account server.

Further, if the financial instrument processing server 300 confirms that the composite token is a virtual certified financial instrument (e.g., the virtual financial instrument is uniquely associated with the composite token), the financial instrument processing server 300 transmits to the payee communications device 200b a notification confirming redemption of the virtual financial instrument in favour of the payee (e.g., in step 422). The payee communications device 200b may generates an audio and/or visual output message from the notification, confirming that the virtual financial instrument was redeemed in favour of the payee.

In one embodiment, instead of the financial instrument processing server 300 redeeming the virtual financial instrument at step S420, after confirming that the composite token is a virtual certified financial instrument the financial instrument processing server 300 confirms to the payee communications device 200b that the financial instrument redemption request was valid (e.g., the financial instrument redemption request was generated from the payor token and the payee token that were associated with the virtual certified financial instrument), and then prompts the payee, through the payee communications device 200b, to select an automated banking machine (ABM), automated teller machine (ATM), or third party printer where the payee would like to obtain a physical certified financial instrument. The financial instrument processing server 300 may provide the payee communications device 200b with a list of ABMs/ATMs or third party printers that are authorized and capable of printing a physical certified financial instrument. The payee communications device may render the provided list for presentation to the payee, and the payee may make selection immediately after the financial instrument processing server 300 confirms that the composite token is a virtual certified financial instrument, or at a later date/time.

Upon receipt of the payee's location selection, at step S420, the financial instrument processing server 300 may generate a print image file to be used to print a physical certified financial instrument that is payable to the payee, and downloads the print image file to the selected location. The financial instrument processing server 300 may then also delete the reference token (and the corresponding database entry of the virtual financial instrument) from the financial instruments database 314.

The payee then attends at the selected ABM/ATM or third party printer, and authenticates to the ABM/ATM or printer. As an example, the payee may authenticate to the ABM/ATM using the authentication credentials (e.g. payment card number and password) that the payee normally uses to authenticate to the ABM/ATM. The payee may authenticate to the third party printer using other acceptable credentials, such as photo identification. After successfully authenticating, the physical certified financial instrument is printed at the ABM/ATM or third party printer using the downloaded print image file. After the physical certified financial instrument is printed, the ABM/ATM or third party printer may transmit a print confirmation to the financial instrument processing server 300, whereupon the financial instrument processing server 300 may delete the reference token (and the corresponding database entry of the virtual financial instrument) from the financial instruments database 314 (if not previously deleted at step S420). The payee may then redeem the physical certified financial instrument in the usual manner.

Certain aspects of the disclosures described herein include process steps and instructions described herein in the form of an algorithm. It should be noted that the process steps and instructions of the consistent with the disclosed embodiments can be embodied in software, firmware or hardware, and when embodied in software, can be downloaded to reside on and be operated from different platforms used by real time network operating systems.

Also described herein are exemplary apparatuses, systems, and devices for performing the operations herein. These apparatuses, systems, and devices may be specially constructed for the required purposes, or may comprise a general-purpose computer selectively activated or reconfigured by a computer program stored in the computer. Such a computer program may be stored in a tangible, non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the embodiments described herein are not described with reference to any particular programming language. It is appreciated that a variety of programming languages may be used to implement the disclosed embodiments, and any references to specific languages are provided for disclosure of enablement and best mode.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

1: A method of issuing a virtual certified financial instrument, comprising:
a financial instrument processing server receiving a financial instrument request for a virtual certified financial instrument for effecting a payment to a payee, generating a payor token and a payee token, generating a reference token from the payor token and the payee token using an algorithm rendering it computationally infeasible for the reference token to be derived from only one of the payor token and the payee token, and uniquely associating the reference token with the virtual certified financial instrument;
the financial instrument processing server transmitting the payor token to a payor device via a first communications channel, and transmitting the payee token to a payee device via a second communications channel distinct from the first communications channel, the payor device being associated with a payor of the virtual financial instrument, the payee device being associated with the payee;
the financial instrument processing server receiving a financial instrument redemption request from one of the payor device and the payee device, the financial instrument redemption request including a composite token; and
the financial instrument processing server redeeming the virtual financial instrument in favour of the payee in accordance with a confirmation that the composite token matches the reference token.

2: The method according to claim 1, wherein the algorithm further renders it computationally infeasible for one of the payor token and the payee token to be derived from the other of the payor token and the payee token.

3: The method according to claim 1, wherein the payor token includes a financial instrument identifier uniquely associated with the virtual financial instrument, the generating a payee token comprises the financial instrument processing server uniquely associating the payee token with the financial instrument identifier r, and the transmitting the payee token to a payee device comprises the financial instrument processing server receiving the financial instrument identifier from the payee device, determining the payee token from the received financial instrument identifier and transmitting the determined payee token to the payee device.

4: The method according to claim 1, wherein the redeeming the virtual financial instrument comprises the financial instrument processing server receiving an indication of a location for printing a physical certified financial instrument, and effecting printing of the physical certified financial instrument at the location using the virtual financial instrument.

5: The method according to claim 1, further comprising the financial instrument processing server confirming, in a payor account associated with the payor, a sufficiency of funds for redemption of the virtual financial instrument prior to uniquely associating the payor token and the payee token with the virtual financial instrument.

6: A financial instrument processing server comprising:
a network interface; and
a computer processing system coupled to the network interface and configured to:
(i) receive a financial instrument request for a virtual certified financial instrument for effecting a payment to a payee;
(ii) generate a payor token and a payee token, generate a reference token from the payor token and the payee token using an algorithm rendering it computationally infeasible for the reference token to be derived from only one of the payor token and the payee token, and uniquely associate the reference token with the virtual certified financial instrument;
(iii) transmit the payor token to a payor device via a first communications channel, and transmit the payee token to a payee device via a second communications channel distinct from the first communications channel, the payor device being associated with a payor of the virtual financial instrument, the payee device being associated with the payee;
(iv) receive a financial instrument redemption request from one of the payor device and the payee device, the financial instrument redemption request including a composite token; and
(v) redeem the virtual financial instrument in favour of the payee in accordance with a confirmation that the composite token matches the reference token.

7: The financial instrument processing server according to claim 6, wherein the algorithm further renders it computationally infeasible for one of the payor token and the payee token to be derived from the other of the payor token and the payee token.

8: The financial instrument processing server according to claim 6, wherein the payor token includes a financial instrument identifier uniquely associated with the virtual financial instrument, the computer processing system is configured to uniquely associate the payee token with the financial instrument identifier, and is further configured to transmit the payee token by receiving the financial instrument identifier from the payee device, determining the payee token from the received financial instrument identifier and transmitting the determined payee token to the payee device.

9: The financial instrument processing server according to claim 6, wherein the computer processing system is configured to redeem the virtual financial instrument by receiving an indication of a location for printing a physical certified financial instrument, and effecting printing of the physical certified financial instrument at the location using the virtual financial instrument.

10: The financial instrument processing server according to claim 6, wherein the computer processing system is configured to confirm, in a payor account associated with the payor, a sufficiency of funds for redemption of the virtual financial instrument prior to uniquely associating the payor token and the payee token with the virtual financial instrument.

11: A tangible, non-transitory computer-readable medium storing instructions which, when executed by at least one processor, cause the at least one processor to perform a method of issuing a virtual certified financial instrument, the method comprising:
the at least one processor receiving a financial instrument request for a virtual certified financial instrument for effecting a payment to a payee, generating a payor token and a payee token, generating a reference token from the payor token and the payee token using an algorithm rendering it computationally infeasible for the reference token to be derived from only one of the payor token and the payee token, and uniquely associating the reference token with the virtual certified financial instrument;
the at least one processor transmitting (i) the payor token to a payor device via a first communications channel, and (ii) the payee token to a payee device via a second communications channel distinct from the first communications channel, the payor device being associated with a payor of the virtual financial instrument, the payee device being associated with the payee;
the at least one processor receiving a financial instrument redemption request from one of the payor device and the payee device, the financial instrument redemption request including a composite token; and
the at least one processor redeeming the virtual financial instrument in favour of the payee in accordance with a confirmation that the composite token matches the reference token.
